(19) United States
(12) Patent Application Publication
(10) Pub. No.: US 2009/0313107 A1
(43) Pub. Date: Dec. 17, 2009

(54) Universal Discount Chip (UDC)

(76) Inventor: Terri D. Austin, New Rochelle, NY (US)

Correspondence Address: Terri D. Austin, 22 Siebrecht Place, New Rochelle, NY, 10804, US

(21) Appl. No.: 12/157,958

(22) Filed: Jun. 16, 2008

(51) Int. Cl. G06Q 30/00

(52) U.S. Cl. 705/14.27

(57) ABSTRACT

A Universal Discount Chip (UDC) is a coding devise placed upon a credit card or a debit card offered by an issuing bank and enabling the card holder to obtain discounts from any and all participating manufacturers, retailers or (hereinafter referred to as “Merchants”) by presenting and scanning the card with the UDC at the point of sale. The issuing bank would collect the necessary data including the name and address of the Merchant, the terms and conditions of the discount. After collecting the data, the issuing bank would apply the discount and reduce the overall amount of the sales transaction. The UDC could be placed on all types of debit or credit cards, including retail store credit cards. The issuing bank would be paid a commission by the Merchant for processing the discount transaction.

### CROSS-REFERENCE TO RELATED APPLICATIONS

Not applicable

### STATEMENT REGARDING FEDERALLY SPONSORED RESEARCH

Not Applicable

### REFERENCE TO SEQUENCE LISTING

Not Applicable

### BACKGROUND OF THE INVENTION

Most consumers carry multiple discount cards from retailers and multiple discount coupons from manufactures. These discount cards and discount coupons occupy unnecessary space in wallets and handbags. The cards and coupons are easily misplaced or left at home when needed at the point of sale. A UDC contained on a banking or credit card would eliminate the need to carry multiple cards and coupons thereby saving space and making shopping more convenient for the consumer.

### BRIEF SUMMARY OF THE INVENTION

A Universal Discount Chip (UDC) is a coding devise placed upon a credit card or a debit card offered by an issuing bank and enabling the card holder to obtain discounts from any and all participating manufacturers or retailers (hereinafter referred to as “Merchant”) by simply presenting and scanning the card with the UDC at the point of sale.

### BRIEF DESCRIPTION OF THE SEVERAL VIEWS OF THE DRAWING

Not Applicable

### DETAILED DESCRIPTION OF THE INVENTION

The UDC would electronically process the discount information to the issuing bank. The issuing bank would receive a commission for all transactions processed. Each Merchant would determine the terms and limits of the offered discount. For instance, Merchant A could offer a 15% discount on all merchandise sold in all stores in all locations for a one week period in September. Merchant B could offer a 10% discount on all low fat yogurt manufactured and distributed in the United States on President's Fitness Day.

1. A system for automating and consolidating discounts offered by multiple retailers and manufacturers whereby a Universal Discount Chip (UDC) would be placed upon a credit or debit card by the issuing bank and scanned by the retailer or consumer at the point of sale to activate the processing of any and all discounts offered by participating merchants. The scope of the protection of the patent would include protection for the process of consolidating and streamlining retail discounting by all participating merchants. This process would save the consumer the time and effort to locate and carry multiple cards and coupons. Merchants would be encouraged to promote use of the UDC by demonstrating the convenience of using the UDC to the consumer. It would also be a way to protect the environment by eliminating the need to produce multiple plastic cards and paper flyers.
